(19) United States
(12) Patent Application Publication
(10) Pub. No.: US 2004/0165851 A1
(43) Pub. Date: Aug. 26, 2004

(54) Optical fiber closure having improved optical fiber connection and tracing features

(75) Inventor: Bassel H. Daoud, Parsippany, NJ (US)

Correspondence Address: Moser, Patterson & Sheridan, LLP, Attorneys At Law, Suite 100, 595 Shrewsbury Avenue, Shrewsbury, NJ, 07702, US

(73) Assignee: LUCENT TECHNOLOGIES INC.

(21) Appl. No.: 10/372,742

(22) Filed: Feb. 24, 2003

(51) Int. Cl. G02B 6/00

(52) U.S. Cl. 385/135

(57) ABSTRACT

Optical fiber closure having improved optical fiber connection and tracing features is described. The optical fiber closure supports a plurality of optical connector panels, each of which includes a plurality of receptacles respectively associated with a first plurality of indicia that is identical for each of the plurality of optical connector panels.

### BACKGROUND OF THE INVENTION

1. Field of the Invention

The present invention generally relates to optical fiber closures and, more particularly, to an optical fiber closure having improved optical fiber connection and tracing features.

2. Description of the Related Art

Optical communications refer to the medium and the technology associated with the transmission of information as light pulses. Many applications utilize an optical fiber network to establish optical communications between network locations. In order to enable optical communication and the flow of optical signals between network locations, various interconnections must be established between different optical fibers.

Referring to FIG. 1a, there is shown a simple ray model of light pulse transmission via a straight optical fiber. The optical fiber 100, shown in longitudinal cross section, has an optical core 102 that is surrounded by a cladding 104 and has a critical angle θ_{c}. FIG. 1b shows a simple ray model of light pulse transmission on a bent optical fiber. As illustrated, when the bend of the optical fiber 100 is such as to cause a light ray to strike the boundary of the core 102 and cladding 104 at an angle greater than the critical angle θ_{c}—the angular excess, as shown in the inset, being labeled θ_{bend}—the light ray leaks out of the optical fiber core. Further, while lower order mode light rays are not likely to leak out of the optical fiber core, they may be transformed into higher order mode light rays and may leak out at a subsequent bend in the optical fiber. Accordingly, it is necessary that an optical fiber be routed so that bends in the optical fiber are of a sufficient radius to substantially avoid occurrence of such extra critical angle, and the associated light leakage.

The minimum bend radius characterizes the radius below which an optical fiber should not be bent to avoid light ray leakage. Typically, the minimum bend radius varies with fiber design. Bending an optical fiber with a radius smaller than the minimum bend radius may result in increased signal attenuation and/or a broken optical fiber.

Optical fibers may be connected together within optical fiber closures. An optical fiber closure typically includes a plurality of optical connector panels, each supporting a specific number of optical connectors for connecting optical fibers. Optical fiber closures contain an increasing number of optical connectors. Optical connector panels are being made to increase the overall number of optical connectors that can be mounted in a single fiber closure. As the optical connectors are placed closer together, it is becoming more difficult to manually manipulate an optical connector panel without adversely affecting the fibers of adjacent optical connectors. For example, the fibers of adjacent optical connectors are subject to over-bending, which can damage the adjacent optical connectors or otherwise deleteriously affect the operation of the adjacent optical connectors.

Furthermore, to ensure proper connection among the various optical fibers within an optical fiber closure, each optical fiber is physically “traced” from one end to another during connection. While performing such a physical tracing procedure, a technician may accidentally over-bend an optical fiber. Such a physical tracing procedure is becoming even more onerous due to the increasing number of optical connectors in a give optical fiber closure.

In addition, to facilitate optical fiber tracing and interconnection, optical connectors are labeled within an optical fiber closure. Conventionally, optical connectors within an optical fiber closure are labeled using a sequential numbering system. For example, if there are 144 optical connectors within an optical fiber closure, each optical connector is labeled with a number ranging from 1 to 144. Such a sequential numbering system requires the use and production of many different variations of identical optical connector panels, each variation having a particular sequence of numbers. Moreover, a particular optical connector panel can only be used in a specific location within an optical fiber closure.

### SUMMARY OF THE INVENTION

These and other deficiencies of the prior art are addressed by the present invention of an optical fiber closure having improved optical fiber connection and tracing features. In one embodiment, an optical fiber closure includes a housing having a partition. The partition includes a frame surrounding a central opening. The frame supports a plurality of optical connector panels. Each of the plurality of optical connector panels includes a plurality of receptacles for supporting optical connectors and a first plurality of indicia respectively associated with the plurality of receptacles. The frame includes a second plurality of indicia respectively associated with the plurality of optical connector panels. Each of the plurality of receptacles for each of the plurality of optical connector panels is uniquely identifiable by respective indicia of the first plurality of indicia and respective indicia of the second plurality of indicia.

In another embodiment, the optical fiber closure further includes a cover pivotally mounted to the housing. An identification label is pivotally mounted to the cover. The identification label includes a face having a plurality of column for identifying optical connector panels and a third plurality of indicia respectively associated with the plurality of columns. Each of the plurality of columns includes a plurality of cells for identifying receptacles and a fourth plurality of indicia corresponding to the first plurality of indicia. The third plurality of indicia corresponds with the second plurality of indicia, and the fourth plurality of indicia corresponds with the first plurality of indicia.

In yet another embodiment, the optical fiber closure includes an optical tracing module mounted within the housing. One or more optical tracing circuits are mounted to a respective one or more of the plurality of optical connector panels and are coupled to the optical tracing module. Each of the optical tracing circuits includes a plurality of switches, a plurality of visual indicator devices respectively associated with the plurality of switches, and a plurality of indicia respective associated with the plurality of switches and corresponding with the first plurality of indicia. Each of the plurality of switches is disposed at an angle to an adjacent one of the plurality of switches.

In yet another embodiment, the frame of the optical fiber closure includes a top portion, a bottom portion, and opposing side portions. The top portion includes an inner edge having a first plurality of notches, and the bottom portion includes an inner edge having a second plurality of notches respectively associated with the first plurality of notches. Each of the plurality of optical connector panels includes a body having a fixed latch member adapted to communicate with one of the first plurality of notches and the second plurality of notches, and a flexible latch member adapted to communicate with the other of the first plurality of notches and the second plurality of notches.

### BRIEF DESCRIPTION OF THE DRAWINGS

So that the manner in which the above recited features of the invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1a is a simple ray model of light pulse transmission for a straight optical fiber;

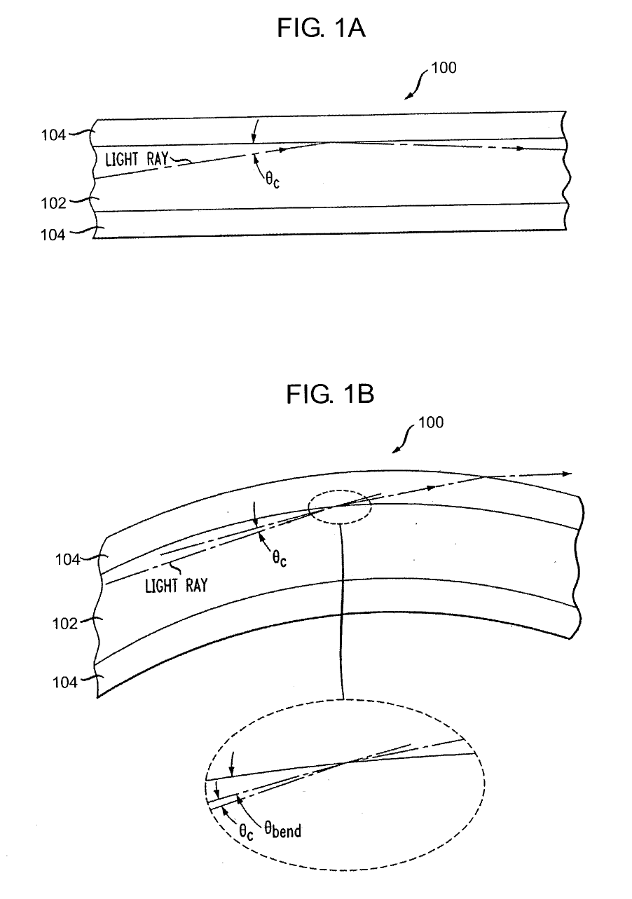

FIG. 1b is a simple ray model of light pulse transmission for a bent optical fiber;

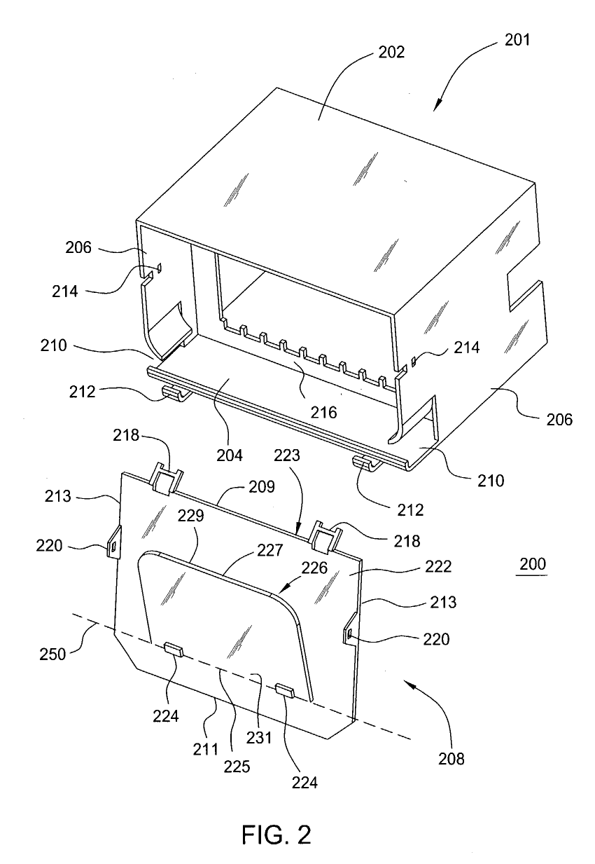

FIG. 2 is an isometric and partially exploded view showing a portion of an exemplary embodiment of an optical fiber closure in accordance with one or more aspects of the invention;

FIG. 3 depicts a front view of the housing of the optical fiber closure depicted in FIG. 2 in accordance with one or more aspects of the invention;

FIGS. 4A through 4D depict an exemplary embodiment of an optical connector panel of the optical fiber closure depicted in FIG. 2 in accordance with one or more aspects of the invention;

FIG. 5 depicts an illustrative identification label of the optical fiber closure depicted in FIG. 2 in accordance with one or more aspects of the invention;

FIG. 6 depicts a diagram showing an exemplary embodiment of an optical tracing circuit in accordance with one or more aspects of the invention; and

FIG. 7 depicts an optical tracing circuit depicted in FIG. 6 within an optical fiber closure in accordance with one or more aspects of the invention.

### DETAILED DESCRIPTION

Optical fiber closure having improved optical fiber connection and tracing features is described. In the following description, numerous specific details are set forth to provide a more thorough understanding of the invention. As will be apparent to those skilled in the art, however, various changes using different configurations may be made without departing from the scope of the invention. In other instances, well-known features have not been described in order to avoid obscuring the invention. Thus, the invention is not considered limited to the particular illustrative embodiments shown in the specification and all such alternate embodiments are intended to be included in the scope of this invention.

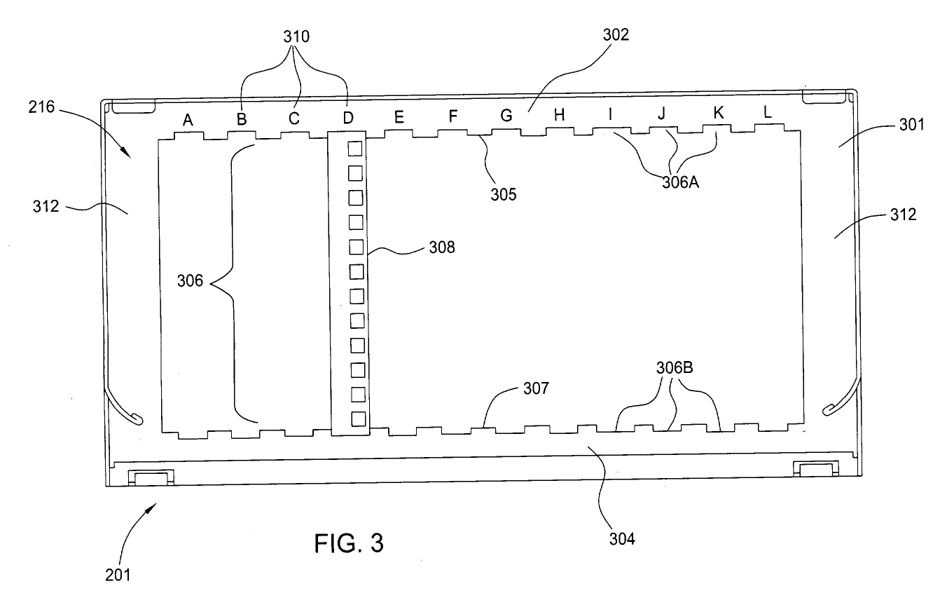

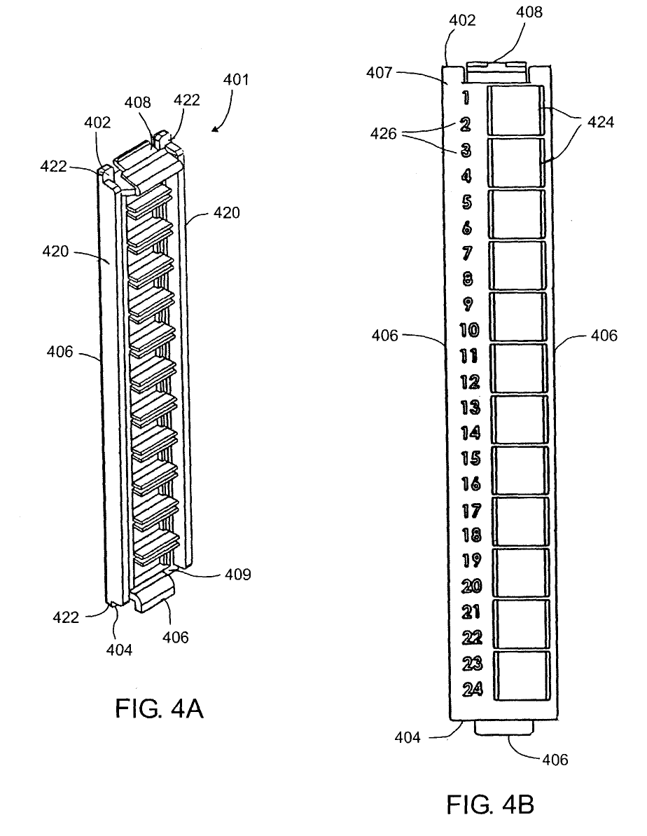

FIG. 2 is an isometric and partially exploded view showing a portion of an exemplary embodiment of an optical fiber closure 200 in accordance with one or more aspects of the invention. The optical fiber closure 200 includes a housing 201 and a front cover 208. Although not shown, the optical fiber closure 200 may include a rear cover substantially similar to the front cover 208. The housing 201 includes a top 202, a bottom 204, and opposing walls 206. The housing 201 may be formed of sheet metal, plastic, or like type materials known to those skilled in the art. Each of the opposing walls 206 illustratively includes an aperture 210 defined therein through which optical fibers may pass. The bottom 204 illustratively includes a pair of hinge members 212 for pivotally supporting the front cover 208, although one or more hinge members 212 may be used. The opposing walls 206 include latch members 214 for securing the front cover 208 in a closed position. The housing 201 may employ any of various types of hinge members 212 and latch members 214 known in the art. The housing 201 includes a partition 216 mounted therein for supporting optical connector panels. The partition 216 is described more fully below with respect to FIG. 3.

The front cover 208 includes a bottom edge 209, a top edge 211, opposing side edges 213, an inside face 222, and an outside face 223. The front cover 208 illustratively includes a pair of hinges 218 proximate the bottom edge 209. The hinges 218 are adapted to be pivotally mounted to the hinge members 212 of the housing 201. The front cover 208 further includes a pair of latches 220 extending from the side edges 213. The latches 220 are adapted to be secured to latch members 214 of the housing. The front cover may be disposed in a closed position by securing the latches 220 with the latch members 214, and may be disposed in an open position by disengaging the latches 220 from the latch members 214. The front cover 208 may be formed of transparent or translucent material, such as plastic.

The inside face 222 includes one or more hinge members 224 (e.g., two are shown) for pivotally supporting an identification label 226. The identification label 226 includes a hinged edge 225 proximate the hinge members 224, a free edge 227 opposite the hinge members 224, and a front face 229 for recording identification indicia, and a back face 231. The front face 229 of the identification label 226 is visible if the front cover 208 is in the closed position. Notably, the free edge 227 of the identification label 226 is proximate to the bottom edge 209 if the front cover 208 is in the closed position. If the front cover 208 is in the open position, the identification label 226 may pivot on the hinge members 224 around axis 250 such that the free edge 227 is opposite the bottom edge 209 and the font face 229 is visible. In this manner, the front face 229 of the identification label 226 may be visible when the front cover 208 is in either of the open or closed positions. By recording identification information on only the front face 229 of the identification label 226, the invention reduces or eliminates the risk of human error. Notably, conventional identification labels are not pivotable and require replication of identification information from one side of the identification label to the other.

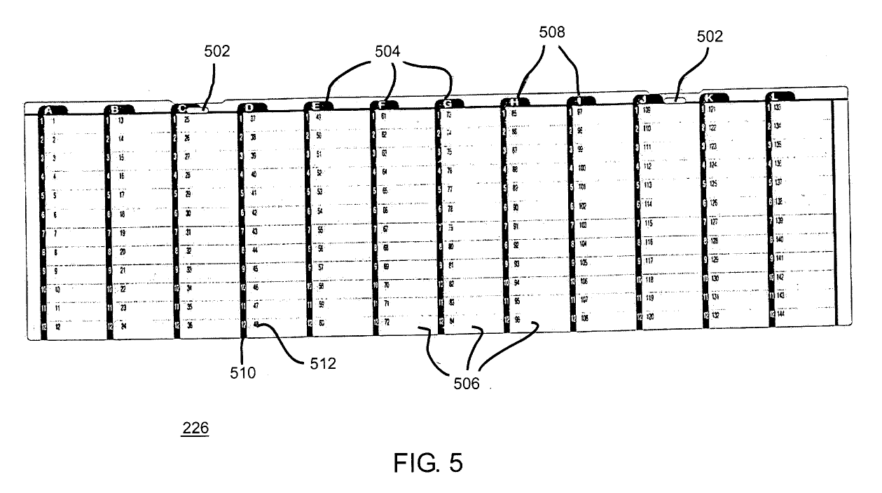

FIG. 5 depicts an illustrative identification label 226 in accordance with one or more aspects of the invention. The identification label 226 includes one or more hinge receptacles 502 (e.g., two are shown) and a plurality of columns 504 (e.g., twelve are shown). The hinge receptacles 502 are adapted for pivotal mounting to the hinge members 224 of the front cover 208. Each of the columns 504 includes a plurality of cells 506 (e.g., twelve are shown). Each of the columns 504 further includes identification indicia 508. The identification indicia 508 illustratively includes alphabetical characters ranging from ‘A’ to ‘L’, consecutively, although other types and numbers of identification indicia may be used. As described more fully below, each of the columns 504 is associated with a respective one of a plurality of optical connector panels. As such, identification indicia 508 are related to the plurality of optical connector panels.

Each of the cells 506 includes identification indicia 510. Notably, the cells 506 associated with each of the columns 504 include identical identification indicia 510. The identification indicia 510 for the cells 506 associated with each of the columns 504 illustratively includes numerical characters ranging from ‘1’ to ‘12’, consecutively, although other types and numbers of identification indicia may be used. As such, each of the columns 504 includes cells 506 having identification indicia 510 ranging from ‘1’ to ‘12’. As described more fully below, each of the cells 506 is associated with a respective one of a plurality of optical connector receptacles in a given optical connector panel. As such, each optical connector receptacle of each optical connector panel may be uniquely identified using the identification indicia 510 and the identification indicia 510. In one embodiment, each of the cells 506 also includes unique identification indicia 512. The unique identification indicia 512 illustratively includes numerical characters ranging from ‘1’ to ‘144’, consecutively, although other types and numbers of identification indicia may be used.

As described below, the identification indicia 508 and 510 may be used with corresponding identification indicia on the partition 216 of the optical fiber closure 200, the optical connector panel 308, and an optical tracing circuit 600. This allows for the use of identical optical connector panels, as well as identical optical tracing circuits, within an optical fiber closure. As such, inventory and costs associated with production of optical connector panels and optical tracing circuits are reduced, since only a single type of optical connector panel or optical tracing circuit must be produced and stocked. For example, given an optical connector panel having twelve optical connector receptacles for connecting two optical fibers, all such optical connector panels may be produced having identification indicia ranging from ‘1’ to ‘24’.

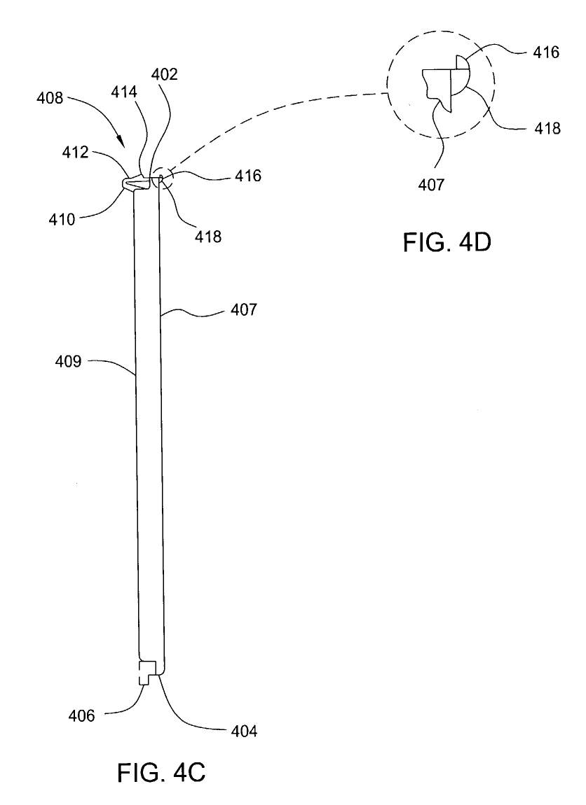

FIG. 3 depicts a front view of the housing 201 in accordance with one or more aspects of the invention. The partition 216 includes a frame 301 surrounding a central opening 303. The frame 301 includes a top portion 302, a bottom portion 304, and lateral opposing side portions 312. An inner edge 305 of the top portion 302 includes a plurality of notches 306A (e.g., twelve are shown). An inner edge 307 of the bottom portion 304 also includes a plurality of notches 306B, where each of the plurality of notches 306B is opposite a respective one of the plurality of notches 306A. The notches 306A and 306B respectively form pairs of notches 306 for supporting optical connector panels, such as an optical connector panel 308. The optical connector panel 308 is described in more detail below with respect to FIGS. 4A through 4D.

The partition 216 may also include a plurality of identification indicia 310 respectively corresponding each pair of notches 306. For example, the identification indicia 310 may be disposed across the top portion 302 of the partition 216. The identification indicia 310 illustratively includes alphabetical characters ranging from ‘A’ to ‘L’, consecutively, although other types and numbers of identification indicia may be used. The identification indicia 310 correspond to each of a plurality of optical connector panels. Although not shown, the backside of the top portion 302 may also include identification indicia identical to the identification indicia 310. The identification indicia 310 may be used along with corresponding identification indicia 508 of the identification label 226 described above with respect to FIG. 5.

FIGS. 4A through 4D depict an exemplary embodiment of the optical connector panel 308 in accordance with one or more aspects of the invention. In particular, FIG. 4A depicts an isometric view of the optical connector panel 308. FIG. 4B depicts a front view of the optical connector panel 308. FIG. 4C depicts a side view of the optical connector panel 308. FIG. 4D depicts an exploded view of a portion of the optical connector panel 308. The optical connector panel 308 may be understood with simultaneous reference to FIGS. 4A through 4D.

The optical connector panel 308 includes a unitary body 401 having a top edge 402, a bottom edge 404, lateral opposing side edges 406, a front face 407, and a back face 409. For example, unitary body may be formed of plastic. The bottom edge 404 includes a fixed latch member 406 integral therewith and extending downward therefrom. The top edge 402 includes a flexible latch 408 integral therewith. As described in more detail below, when supported in an optical fiber closure, the optical connector panel may be removed therefrom by manipulating only the flexible latch 408. In this manner, the optical connector panel 308 may be removed from an optical fiber closure using a single finger. This is in contrast to conventional optical connector panels that require the manipulation of two latches for removal thereof. Use of a single latch for removal reduces or eliminates the risk of bending optical fibers around the optical connector panel 308. In addition, the unitary body 401 reduces material and labor costs as compared to conventional optical connector panels, which have a plurality of component parts, such a separate body, individual latches, and individual optical connector receptacles.

In an embodiment, the fixed latch member 406 is offset from the front face 407 and may be substantially flush with the back face 409. The flexible latch 408 includes a first member 410 extending outward from the back face 409 and cantilevered from the top edge 402, and a second member 412 extending inward towards the back face 409 and cantilevered from the first member 410. The second member 412 has a front edge 418 that extends outward from the front face 407. The second member 412 includes a tapered lip 414 and a third member 416 extending upward from the second member 412 at the front edge 418. The first member 410 and the second member 412 are flexible in that a downward force applied to the second member 412 causes the first member 410 and the second member 412 to compress and move downward with respect to the top edge 402. Removal of a hitherto applied downward force will cause the first member 410 and the second member 412 to uncompress and move upward with respect to the top edge 402. Those skilled in the art will appreciate that other types of fixed and flexible latch pairs may be used with the invention such that the optical connector panel may be removed from an optical fiber closure using only the flexible latch.

In an embodiment, the side edges 406 include sidewalls 420 extending outward from the back face 409. Each of the sidewalls 420 extends along a respective one of the side edges 406 and is offset from both the top edge 402 and the bottom edge 404 forming shoulders 422. The sidewalls 420 improve the structural integrity of the optical connector panel 308. The sidewalls 420 may be tapered inward as they extend outward from the back face 409 to facilitate insertion of the optical connector panel 308 between two adjacent optical connector panels in an optical fiber closure.

The optical connector panel 308 further includes a plurality of receptacles 424 (e.g., twelve are shown) for supporting optical connectors. Various types of receptacles 424 may be used, such as receptacles for ST, SC, FC, LC, and like type optical connectors. The receptacles 424 are offset in that they are disposed nearer one of the side edges 406 than the other of the side edges 406. The offset receptacles 424 allow room for the addition of an optical tracing circuit, such as the optical tracing circuit 600 described below. A plurality of identification indicia 426 (twenty four are shown) are disposed along the front face 407 respectively corresponding to the plurality of receptacles (e.g., a pair of identification indicia for receptacles that connect two optical fibers). The identification indicia 426 illustratively includes numerical characters ranging from ‘1’ to ‘24’, consecutively, although other types and numbers of identification indicia may be used. The identification indicia 426 may be used along with the identification indicia 510 of the identification label 226 described above with respect to FIG. 5. In an embodiment, the identification indicia 426 may be inwardly molded with respect to the front face 407 to facilitate the addition of an optical tracing circuit. Although not shown, the back face 409 may also include identification indicia identical to the identification indicia 426 disposed along one of the sidewalls 420, for example.

Mounting of the optical connector panel 308 within the housing 201 may be understood with simultaneous reference to FIG. 3. The fixed latch member 406 communicates with a respective one of the notches 306B. The flexible latch 408 communicates with one of the notches 306A that is paired with the respective one of notches 306B communicating with the fixed latch member 406. To insert the optical connector panel 308, the fixed latch member 406 is engaged with one of the notches 306B. As the tapered lip 414 of the flexible latch 408 contacts the corresponding one of the notches 306A, the flexible latch 408 is compressed. Once the tapered lip 414 is out of contact with the corresponding one of the notches 306A, the flexible latch 408 is uncompressed. The optical connector panel 308 is retained between the inner edge 305 and the outer edge 307. The shoulders 422 are substantially flush against the top portion 302 and the bottom portion 304 of the frame 301.

As described above, the optical connector panel 308 may be quickly removed from the housing 301 using a single finger or tool. Notably, a single finger or tool may-compress the flexible latch 408. Since only a single finger or tool is required to remove the optical connector panel, the risk of disturbing optical fibers located around the optical connector panel 308 is substantially reduced or eliminated. Furthermore, the identification indicia 426 of the optical connector panel 308 reduces inventory and costs, since only a single type of optical connector panel must be produced and stocked. For example, when used in conjunction with the identification indicia 310 of the partition 216 and the identification indicia 508 and 510 of the identification label 226, only a single type of optical connector panel 308 may be used having identification indicia 426 ranging from ‘1’ to ‘24’. Although the optical fiber closure 201 has been described as including a partition 216 for supporting optical connector panels 308, those skilled in the art will appreciate that other types of optical connector panels may be used within a respective partition for supporting such optical connector panels.

As described in more detail below, the identification indicia 508 and 510 allows for the use of identical optical connector panels as well as identical electronic optical tracing circuits within an optical fiber closure. As such, the identification indicia 508 and 510 reduce inventory and costs, since only a single type of optical connector panel and electronic optical tracing circuit must be produced and stocked.

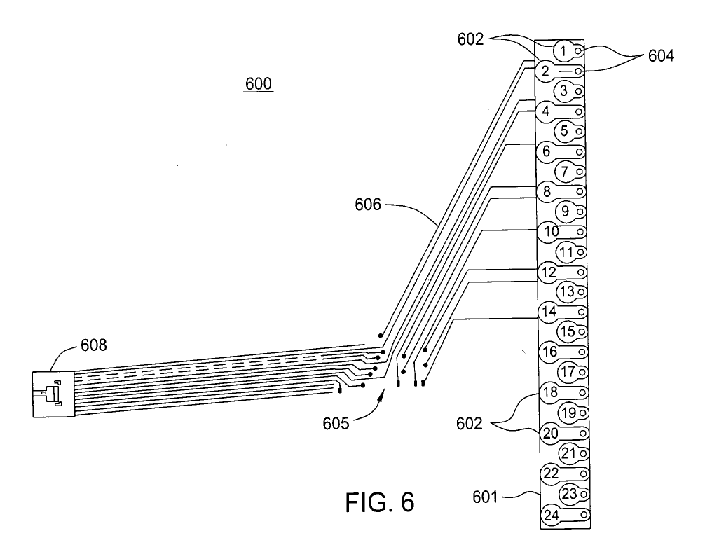

FIG. 6 depicts a diagram showing an exemplary embodiment of an optical tracing circuit 600 in accordance with one or more aspects of the invention. The optical tracing circuit 600 includes a circuit portion 601 and a flexible circuit board 605, such as a printed wiring board (PWB). In an embodiment, the circuit portion 601 is a microcircuit having a plurality of switches 602 (e.g., twenty-four are shown) and a plurality of light-emitting diodes (LEDs) 604 respectively associated with the switches 602. For example, the switches 602 may be push-button switches. The microcircuit 601 includes an adhesive backside for securing the optical tracing circuit 600 to an optical connector panel, such as the optical connector panel 308 described above. Although the invention is described as having a plurality of LEDs, those skilled in the art will appreciate that any type of visual indicator devices may be associated with the plurality of switches 602.

The switches 602 are disposed in a staggered configuration on the circuit portion 601. Notably, each one of the switches 602 is disposed at an angle with respect to an adjacent one of the switches 602. The staggered placement of the switches 602 provides a larger clearance area when compared to an “in-line” arrangement of switches. The staggered placement of switches 602 reduces the risk of pressing two of the switches 602 simultaneously. In addition, the staggered placement of switches 602 increases the density of switches on the circuit portion 601.

The buttons 602 include identification indicia 610. The identification indicia 610 illustratively includes numerical characters ranging from ‘1’ to ‘24’ consecutively, although other types and numbers of identification indicia may be used. The identification indicia 610 are used to identify a particular optical connector disposed within an optical connector panel. As such, when the optical tracing circuit is secured to an optical connector panel, each of the buttons 602 and the respective LEDs 604 corresponds to an optical connector within the optical connector panel.

The circuit 601 is coupled to the PWB 605. The PWB 605 includes a tapered side 606 in order to facilitate access to the rear side of the optical connectors within an optical connector panel. The PWB 605 includes an electrical connector 608 for coupling the optical tracing circuit to an optical tracing module as described more fully below. Operation of optical tracing circuit 600 to trace the connection of optical fibers is well-known in the art.

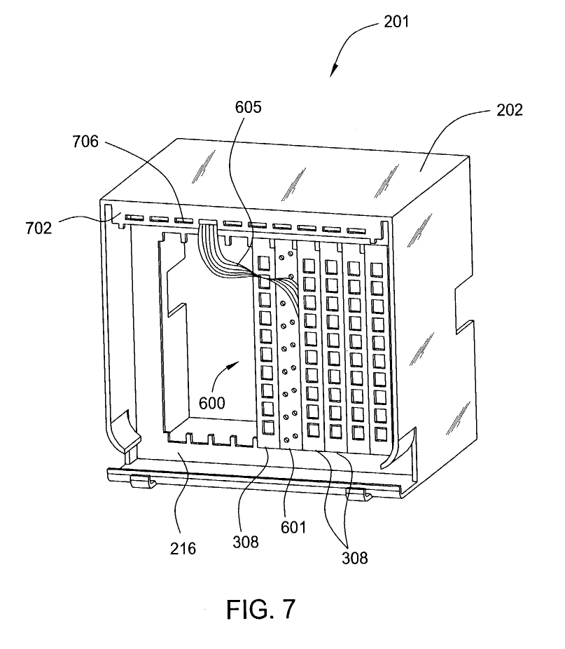

FIG. 7 depicts an isometric view showing the optical tracing circuit 600 within an optical fiber closure 201 in accordance with one or more aspects of the invention. Elements in FIG. 7 that are the same or similar to elements depicted in FIGS. 2 and 3 are designated with identical reference numerals and are described in detail above. An optical tracing module 702 is mounted within the housing 202. The optical tracing module 702 includes various well-known circuit elements for facilitating the tracing of optical fiber connections utilizing optical tracing circuits. The circuit portion 601 of the optical tracing module 600 is secured to an optical connector panel 308. The electrical connector 608 is secured for electrical communication with a receptacle 706 of the optical tracing module 702. Operation of the optical tracing module 702 and the optical tracing circuit 600 is well-known in the art.

While the foregoing is directed to illustrative embodiments of the invention, other and further embodiments of the invention may be devised without departing from the basic scope thereof, and the scope thereof is determined by the claims that follow.

1. An optical fiber closure, comprising:
a housing including a partition having a frame surrounding a central opening;
a plurality of optical connector panels supported in the frame, each of the plurality of optical connector panels including a plurality of receptacles for supporting optical connectors and a first plurality of indicia respectively associated with the plurality of receptacles;
the frame including a second plurality of indicia respectively associated with the plurality of optical connector panels.

2. The optical fiber closure of claim 1, wherein the first plurality of indicia includes at least one of numerical reference characters and alphabetical reference characters, and the second plurality of indicia include the other of numerical reference characters and alphabetical reference characters.

3. The optical fiber closure of claim 1, wherein each of the plurality of receptacles for each of the plurality of optical connector panels is uniquely identifiable by respective indicia of the first plurality of indicia and respective indicia of the second plurality of indicia.

4. The optical fiber closure of claim 1, further comprising:
a cover pivotally mounted to the housing; and
an identification label pivotally mounted to the cover, the identification label including a face having a plurality columns for identifying optical connector panels and a third plurality of indicia respectively associated with the plurality of columns, each of the plurality of columns including a plurality of cells for identifying receptacles and a fourth plurality of indicia respectively associated with the plurality of cells, the third plurality indicia corresponding to the second plurality of indicia and the fourth plurality of indicia corresponding to the first plurality of indicia.

5. The optical fiber closure of claim 4, wherein the cover is configured to pivot between a closed position with respect to the housing and an open position with respect to the housing, and the identification label is configured to pivot in a first position if the cover is in the closed position and in a second position if the cover is in the open position, the face of the identification label being visible if the identification label is in either of the first or second positions.

6. The optical fiber closure of claim 1, further comprising:
an optical tracing module mounted within the housing; and
one or more optical tracing circuits mounted to a respective one or more of the plurality of optical connector panels and coupled to the optical tracing module, each of the optical tracing circuits including a plurality of switches, a plurality of visual indicator devices respectively associated with the switches, and a third plurality of indicia respectively associated with the plurality of switches, the third plurality of indicia corresponding with the first plurality of indicia.

7. The optical fiber closure of claim 6, wherein each of the one or more optical tracing circuits comprises:
a circuit portion having the plurality of switches and the plurality of visual indicator devices, each one of the plurality of switches being disposed on the circuit portion at an angle to an adjacent one of the plurality of switches; and
a flexible circuit board coupled to the circuit portion, the flexible circuit board including an electrical connector for coupling the optical tracing circuit to the optical tracing module.

8. The optical fiber closure of claim 1, wherein the frame includes a top portion, a bottom portion, and opposing side portions, the top portion including an inner edge having a first plurality of notches, the bottom portion having an inner edge having a second plurality of notches respectively associated with the first plurality of notches.

9. The optical fiber closure of claim 8, wherein each of the plurality of optical connector panels comprises a body including a fixed latch member adapted to communicate with one of the first plurality of notches and the second plurality of notches, and a flexible latch member adapted to communicate with the other of the first plurality of notches and the second plurality of notches.

10. An optical connector panel, comprising:
a body including a top, a bottom, and opposing sides;
a fixed latch member integral with the body and proximate one of the top and the bottom;
a flexible latch member integral with the body and proximate the other of the top and the bottom;
a plurality of receptacles for supporting optical connectors, the plurality of receptacles disposed along a longitudinal axis of the body nearer one of the opposing sides than the other of the opposing sides; and
a plurality of indicia respectively associated with the plurality of receptacles, the plurality of indicia disposed along the longitudinal axis of the body proximate the plurality of receptacles.

11. The optical connector panel of claim 10, further comprising opposing sidewalls extending outward from the body and respectively disposed along the opposing sides.

12. The optical connector panel of claim 11, wherein each of the opposing sidewalls is tapered as each of the opposing sidewalls extends outward from the body.

13. The optical connector panel of claim 10, wherein the plurality of indicia is inwardly molded with respect to the body.

14. The optical connector panel of claim 10, wherein the body includes a front and a back, the first plurality of indicia being disposed on the front, the optical connector panel further comprising a second plurality of indicia respectively associated with the plurality of receptacles and corresponding to the first plurality of indicia, the second plurality of indicia being disposed on the back along the longitudinal axis of the body.

15. An optical tracing circuit adapted to be supported by an optical connector panel, the optical tracing circuit comprising:
a circuit portion having a plurality of switches and a plurality of visual indicator devices respectively associated with the plurality of switches, each one of the plurality of switches being disposed on the circuit portion at an angle to an adjacent one of the plurality of switches, the circuit portion adapted to be supported on a face of an optical connector panel;
a flexible circuit board coupled to the circuit portion, the flexible circuit board including an electrical connector for coupling the optical tracing circuit to an optical tracing module; and
a plurality of indicia respectively associated with the plurality of switches.

16. The optical tracing circuit of claim 15, wherein each of the plurality of switches is a button.

17. The optical tracing circuit of claim 15, wherein each of the plurality of visual indicator devices is a light-emitting diode.

18. The optical tracing circuit of claim 15, wherein the flexible circuit board is a printed wiring board.
